(19) United States
(12) Patent Application Publication
(10) Pub. No.: US 2010/0300094 A1
(43) Pub. Date: Dec. 2, 2010

(54) SYSTEM FOR POWER GENERATION BY MEANS OF A STEAM POWER UNIT, AND METHOD THEREFOR

(76) Inventors: Johannes Gross, Berlin (DE); Axel Sperber, Edemissen (DE)

Correspondence Address: DAVID A. GUERRA;INTERNATIONAL PATENT GROUP, LLC, Suite 700, 1816 Crowchild Trail N.W., CALGARY, AB, T2M 3Y7, CA

(21) Appl. No.: 12/676,949

(22) PCT Filed: Sep. 4, 2008
(86) PCT No.: PCT/IB08/02676

§ 371 Date: Jul. 12, 2010

(30) Foreign Application Priority Data
Sep. 7, 2007 (DE) 10 2007 042 541.6

(51) Int. Cl. F03G 4/00

(52) U.S. Cl. 60/641.2

(57) ABSTRACT

The invention relates to a system for power generation by means of a steam power unit, having a geothermal system part for utilizing geothermal energy, characterized in that a drying unit for material comprising agents that can evaporate is operationally coupled downstream of the steam power unit.

The present invention relates to a system for power generation, having a geothermal system part for utilising geothermal energy.

Geothermal systems are now already extensively known. With such geothermal systems the heat extracted from a removal bore is passed for power generation to a steam power unit which operates, for example, according to the Kalina Cycle process or the ORC process, and is converted into electrical energy. The heat is transported by means of a liquid medium such as, for example, water. The water cooled after the power generation is introduced back into the Earth via an injection bore and after heating, is extracted again via the removal bore. The entire process forms a cycle. The level of the temperature of the extracted water is crucial for the efficiency. However, the higher the temperature of the extracted water, the greater the efforts that must be made to bring the water used in the steam power unit to a low temperature which is crucial for the process efficiency. To this end, the water must be cooled at this point before it is introduced into the injection bore. Frequently, the temperatures of the extracted water are not sufficiently high to produce power thereby in a steam power unit. In these cases, such a steam power unit is dispensed with and only the heat obtained is used. Even with such pure utilization of heat, residual heat will persist which must be removed before returning, e.g. by cooling.

Such cooling is very inefficient and pollutive since a large amount of energy and/or cooling water is required.

In order to obtain high temperatures when extracting water, it is necessary to drill to great depths. The geological horizons suitable for the extraction of water are not always located at the desired great depths so that it is usually necessary to work with the extraction temperatures obtained as a function of the suitable geological horizons. This can have the result that a geothermal system is unsuitable for generating power and can be used exclusively for generating heat.

The object of the invention is therefore to further develop a system for power generation having a geothermal system part of the type specified initially in such a manner that the residual heat present before the return can be removed without substantial cooling.

A further aspect of the present invention is to further develop the system for power generation having a geothermal system part in such a manner that the inlet temperature at a steam power unit is higher than the temperature of a removal bore attainable as a result of the geological conditions and at the same time, the temperature of the water on the outlet side of the steam power unit need not be cooled or need only be slightly cooled.

The object is achieved by a drying unit for materials comprising agents that can evaporate being operationally coupled to the geothermal system part.

By coupling a drying unit to the geothermal system, the residual heat of the water used only for heat dissipation is also used for drying moist materials. By withdrawing the heat from the water, the temperature is lowered to such an extent that further cooling for the water before entry into the injection bore is no longer required. In addition, the residual heat still present after the power generation can be used for a further process which otherwise would be assigned to a cost-intensive separate generation of heat. This coupling results in a significant reduction in the water temperature.

By coupling a drying unit to the steam power unit, the heat of the water emerging from the steam power unit is also used for drying moist materials. By withdrawing the heat from the water, the temperature is reduced to such an extent that further cooling for the water before entry into the injection bore is no longer required. In addition, the residual heat still present after the power generation can be used for a further process which otherwise would be assigned to a cost-intensive separate generation of heat. This coupling also results in a significant reduction in the water temperature.

A further advantage according to the present invention is that a boiler system for combustion of the materials released from the agents that can evaporate in the drying unit can be coupled to the drying unit, the boiler unit being connected to the inlet side of the steam power unit via a heat output line. This makes it possible for the materials dried in the drying unit to be supplied to combustion which again generates heat. This heat is advantageously used to increase the temperature of the water extracted from the removal bore on the inlet side of the steam power unit. This also leads to an increase in the efficiency of the steam power unit.

A further advantage is that the steam power unit is disposed between a removal bore of the geothermal system part and the drying unit. The system structure is significantly optimised through this arrangement.

A further advantage of the present invention is when the steam power unit of the system according to the invention operates according to the Kalina cycle process or the ORC process. The advantage is then further increased as required if the system additionally operates with a steam power turbine.

The object of the present invention is additionally achieved by a method according to claim 6. Such a method for power generation using a system as has been described previously is characterised according to the invention in that before return, the fluid is passed through a heat exchanger in which some of the residual heat of the fluid is transferred from a drying medium in a drying unit for drying materials comprising agents that can evaporate in order to evaporate the agents that can evaporate, which are contained in the material.

Further advantages of the present invention are obtained from the features of the dependent claims.

One embodiment of the present invention is described in detail hereinafter with reference to the single figure with an integrated steam power unit. The figure shows a schematic diagram of a system for power generation having a geothermal system part and a steam power unit according to the present invention.

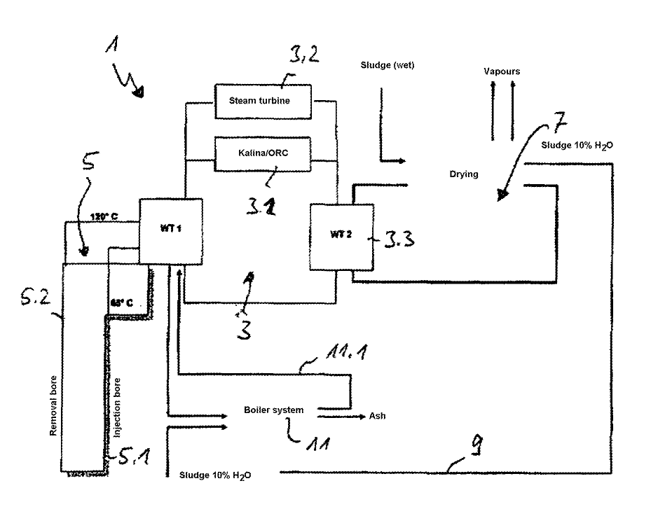

FIG. 1 shows a system 1 for power generation by means of a steam power unit 3. The system 1 also comprises a geothermal system part 5 and a drying unit 7.

The geothermal system part comprises a removal bore 5.1 and an injection bore 5.2. Water at a lower temperature, for example, 65° C. is pressed into the injection bore 5.2. Water having a higher temperature, for example, about 120° C., is extracted from the removal bore 5.1. The water having the higher temperature is introduced into the steam power unit 3. Such a steam power unit 3 operates, for example, according to the Kalina cycle process or the ORC process 3.1 and can be additionally expanded by a steam turbine 3.2.

In the steam power unit 3 the heat transported by the water coming from the removal bore 5.1 is converted into electrical energy. The processes are known and will not be described further here.

The steam power unit 3 is coupled to a heat exchanger 3.3 with the drying unit 7. The drying unit 7 uses the heat transferred from the heat exchanger 3.3 for drying a wet material comprising agents that can evaporate, which has been brought to the drying device 7. Such a wet material comprising agents that can evaporate is, for example, sludge. In the course of the drying the agents that can evaporate, evaporate to a residual moisture of about 10% water. The material dried in the drying device 7 is then conveyed via a line 9 into a boiler system 11 in which the material is combusted. The combustion of the material produces heat which is supplied via a heat output line 11.1 on the inlet side of the steam power unit 3 to the higher-temperature water coming from the removal bore 5.1 so that its temperature is further increased.

Separate operation of individual system parts is also possible.

### REFERENCE LIST

1 System
3 Steam power unit
3.1 Kalina/ORC process
3.2 Steam turbine
3.3 Heat exchanger
5 Geothermal system part
5.1 Removal bore
5.2 Injection bore
7 Drying device
9 Line
11 Boiler system
11.1 Heat output line

1. A system for power generation, having a geothermal system part for utilising geothermal energy, characterised in that a drying unit (7) for material comprising agents that can evaporate is operationally coupled to the geothermal system part (5).

2. The system according to claim 1, characterised in that a steam power unit (3) is provided to which the drying unit (7) is operationally coupled downstream.

3. The system according to claim 2, characterised in that a boiler system (11) for combustion of the materials released from the agents that can evaporate in the drying unit (7) is connected to the drying unit (7), wherein the boiler unit (11) is connected via a heat output line (11.1) to an inlet side of the steam power unit (3).

4. The system according to claim 2 or 3, characterised in that the steam power unit (3) is disposed between the removal bore (5.2) of the geothermal system part (5) and the drying unit (7).

5. The system according to any one of claims 2 to 4, characterised in that the steam power unit (3) operates according to the Kalina cycle process or the ORC process.

6. The system according to claim 5, characterised in that a steam power turbine is connected to the Kalina cycle or the ORC process.

7. A method for power generation with a system according to any one of claims 1 to 6, comprising the steps:
providing a removal bore and an injection bore;
extracting a fluid having a first higher temperature from the removal bore; and
returning the fluid into the injection bore,
characterised in that before return, the fluid is passed through a heat exchanger in which some of the residual heat of the fluid is transferred from a drying medium in a drying unit for drying materials comprising agents that can evaporate in order to evaporate the agents that can evaporate, which are contained in the material.

8. The method according to claim 8, characterised in that
a steam power unit is provided
and after extraction, the fluid is passed through a steam power unit before the fluid is passed via the heat exchanger associated with the drying unit at a second lower temperature into the injection bore.

9. The method according to claim 8, characterised in that the materials substantially released from the substances that can evaporate are transferred into a boiler system and combusted there, wherein the heat thereby increased is supplied to the fluid extracted from the first removal bore having a first higher temperature in order to increase the effective power of the steam power unit.

10. The method according to claim 8 or 9, characterised in that the material comprising agents that can evaporate is introduced into the drying unit in the wet state.

11. The method according to any one of claims 8 to 10, characterised in that the material comprising agents that can evaporate is dried in the drying unit to a residual water content of about 10%.

12. The method according to any one of claims 8 to 11, characterised in that a sludge is selected as material comprising agents that can evaporate.

13. The method according to any one of claims 9 to 12, characterised in that a unit operating according to the Kalina cycle process is selected as the steam power unit.

14. The method according to any one of claims 9 to 12, characterised in that a unit operating according to the ORC process is selected as the steam power unit.

15. The method according to any one of claims 9 to 14, characterised in that a steam power turbine is additionally connected to the steam power unit.
